(19) United States
(12) Patent Application Publication
(10) Pub. No.: US 2015/0310734 A1
(43) Pub. Date: Oct. 29, 2015

(54) METHOD OF LABELING A PLURALITY OF ELECTRIC DEVICES

(71) Applicant: GRAND MATE CO., LTD., Taichung (TW)

(72) Inventors: CHUNG-CHIN HUANG, Taichung (TW); CHIN-YING HUANG, Taichung (TW); HSIN-MING HUANG, Taichung (TW); HSING-HSIUNG HUANG, Taichung (TW); YEN-JEN YEH, Yunlin (TW)

(73) Assignee: GRAND MATE CO., LTD., Taichung (TW)

(21) Appl. No.: 14/260,061

(22) Filed: Apr. 23, 2014

(51) Int. Cl. G08C 17/02

(52) U.S. Cl. CPC G08C 17/02; G08C 2201/92; G08C 2201/20; G08C 2201/70

(57) ABSTRACT

A method of labeling electric devices incorporated in a remote control system, which includes a remote control device, an access point, an interpreter, and a plurality of electric devices. Each electric device has an identifying code. The remote control device has a first memory, and is installed with an application for controlling the electric devices. The interpreter has a second memory. The method first transmits the identifying code of each electric device to the remote control device, and then establishes a plurality of register data which respectively contain one of the identifying code and a corresponding label. The register data respectively correspond to one of the electric devices, and are saved in the first and the second memory.

### BACKGROUND OF THE INVENTION

1. Technical Field

The present invention relates generally to a system for controlling electric devices, and more particular to a method of labeling a plurality of electric devices.

2. Description of Related Art

Remote control is more and more popular in present days to control electric devices without having to walk to the devices. Typically, one remote control is matched with one electric device in a one-to-one relation, which means that each electric device has a specified remote control to control it. There may be electric devices of the same model in different rooms. For this situation, the user may control these electric devices with one remote control. However, we still provide a plurality of remote controls in each room for convenient.

With advance of technology, user may control a specified electric device with a mobile device installed with a control application. It may control the electric device as well as monitor the electric device. One may control different electric devices with one mobile device as long as the mobile device is installed with different control applications. However, how to identify each electric device, especially the electric devices of the same model, becomes a new problem in this kind of remote control.

### BRIEF SUMMARY OF THE INVENTION

In view of the above, the primary objective of the present invention is to provide a method of labeling different electric devices with an application.

The present invention provides a method of labeling electric devices, which is incorporated in a remote control system, and the remote control system includes a remote control device, an access point, an interpreter, and a plurality of electric devices, wherein the remote control device and the interpreter are connected to the access point, and the electric devices are connected to the interpreter for signal transmission; the remote control device has a first memory, and the interpreter has a second memory; the remote control device is installed with an application to be operated by a user to control the electric devices; and each electric device has an identifying code for identification. The method includes the following steps: A. transmit the identifying codes of the electric devices to the remote control device; B. combine a label respectively to each identifying code to form a register datum, and saving the register data in the first memory of the remote control device, wherein each label respectively contains information of one of the electric devices; C. transmit the register data to the interpreter and saving the register data in the second memory.

With such design, electric devices in a family could be registered in a single application for better management. Even if there are electric devices of the same model located at different rooms or floors, they could be still clearly identified in the application.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a sketch diagram of the remote control system of a preferred embodiment of the present invention; and

FIG. 2 is a sketch diagram of the demonstration of the application of the preferred embodiment of the present invention.

### DETAILED DESCRIPTION OF THE INVENTION

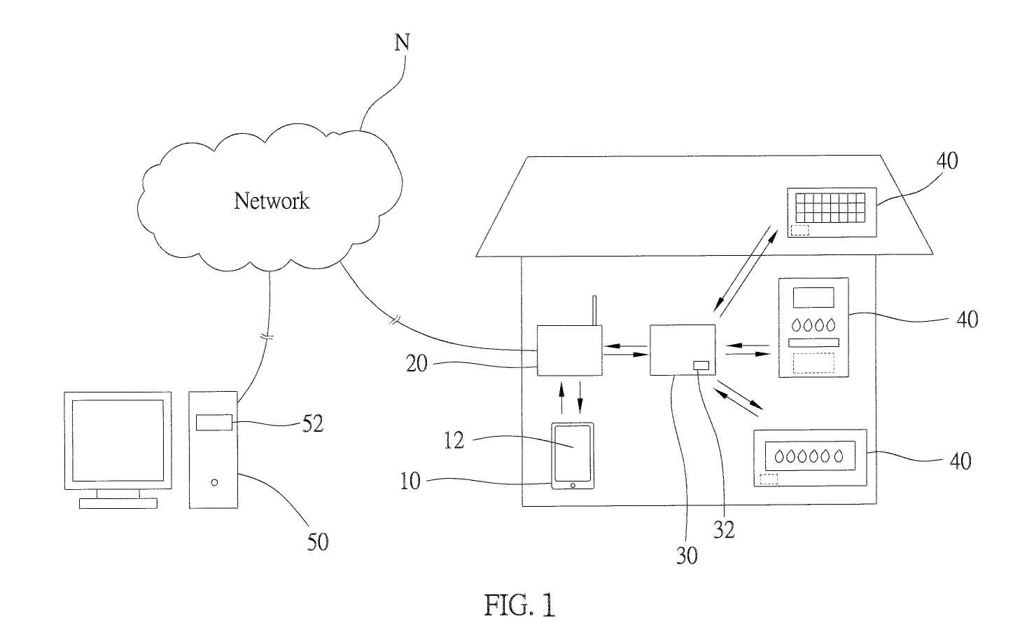

FIG. 1 shows a remote control system 100 of the preferred embodiment of the present invention, which includes a remote control device 10, an access point 20, an interpreter 30, a plurality of electric devices 40, and a server 50. The remote control device 10, the interpreter 30, and the server 50 respectively are connected to the access point 20, and the electric devices 40 are connected to the interpreter 30 for signal transmission. In an embodiment, the server 50 is connected to the access point 20 through a network N and in another embodiment, the network N is Internet. The remote control device 10 has a first memory and a display 12. The interpreter 30 has a second memory 32. The server 50 has a third memory 52. The remote control device 10 is installed with an application to remotely control the electric devices 40. Each electric device 40 has an identifying code for identification. In an embodiment, each identifying code is a series number given by the manufacturer, so that even those electric devices of the same model have different identifying codes. Each identifying code may include basic information of the corresponding electric device 40, such as its type, model, date of manufacture, etc. The electric devices 40 could refer to any device that is controllable with the remote control device 10 of the present invention In other words, the electric devices 40 could even be water heaters, gas stoves, fireplaces, or any other gas appliances that can be remotely controlled.

FIG. 1 demonstrates the electric devices 40 of some types, including an air condition, a water heater, and a fireplace. What is shown in FIG. 1 is just an example, and the types and locations of the electric devices 40 are certainly not limitations on the use of the remote control system 100 of the present invention. In an embodiment, the remote control device 10 is a tablet, and the display 12 is a touch screen of the tablet. The application is executed on the tablet, and the user is able to interact with the application through the touch screen, and of course, information can be shown on the touch screen.

A method of labeling electric devices of the present invention includes the following steps. First, the identifying codes of the electric devices 40 are transmitted to the remote control device 10 through the access point 20 and the interpreter 30. In an embodiment, the identifying codes are saved in the second memory 32 of the interpreter 30 while they are transmitted to the interpreter 30.

After the remote control system 100 receives the identifying codes, the application adds a label to each identifying code, and each identifying code and its corresponding label are combined to form a register datum of one of the electric device 40. In other words, each electric device 40 has a register datum for identification and labeling. Each label may include a description and a picture. In the preferred embodiment, the description describes the type and location of the corresponding electric device 40, and the picture shows an appearance of the corresponding electric device 40 with its location in background. Of course, the description and the picture could contain more (or even less) information about the corresponding electric device 40 in other embodiments.

The register data of the electric devices 40 are saved in the first memory of the remote control device 10, and they are transmitted to the interpreter 30 and the server 50 to be saved in the second memory 32 and the third memory 52 respectively. The purpose of saving the register data in the second memory 32 is for data synchronization, and the purpose of saving them in the third memory 52 is for data backing up.

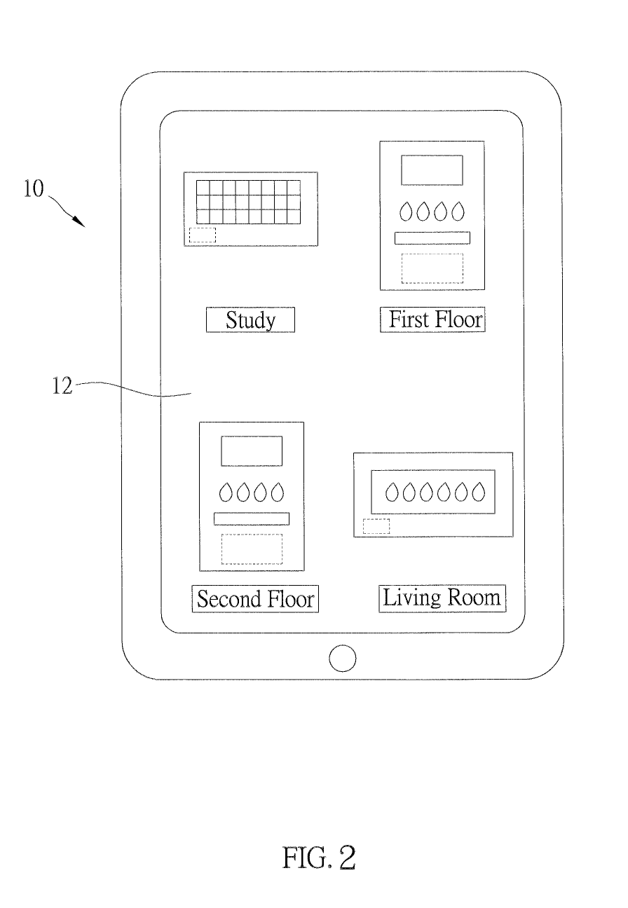

The register data of the electric devices 40 are shown on the touch screen 12 of the tablet 10 in the form of a picture of each electric device 40 with a text describing its location. As shown in FIG. 2, the touch screen 12 clearly shows that there are four electric devices 40, which include an air condition in a study, a water heater on the first floor, another water heater on the second floor, and a fireplace in a living room, and these electric devices 40 are ready to be controlled with the tablet 10. The user may touch the picture or the text of one of the electric devices 40 on the touch screen 12 to control it. The types and locations of the electric devices 40 shown on the touch screen 12 are nothing but for description. It is noted that there are two water heaters on the touch screen 12, and the user would not confuse the water heater on the first floor with the other one on the second floor with the help of the register data.

If there is another remote control device 10 added in the remote control system 100, the register data saved in the second memory 32 of the interpreter 30 can be retrieved and saved in the first memory of the newly added remote control device 10.

Therefore, the newly added remote control device 10 will have the full function of controlling the electric devices 40. The second memory 32 of the interpreter 30 works as a data synchronization center to synchronize the register data in each remote control device 10. Similarly, if there is another electric device 40 added in the remote control system 100, the register datum of the newly added electric device 40 will be saved in the first memory of the remote control device 10, and then transmitted to the interpreter 30 to be saved in the second memory 32.

Furthermore, the user is able to edit any of the register data with the remote control device 10. In an embodiment, only the labels are allowed to be edited. Any edited register data will be saved in the first memory of the remote control device 10, and transmitted to the interpreter 30 and the server 50 to be saved in the second and the third memories 32, 52 respectively. The original corresponding register data will be overwritten. As a result, the remote control device 10, the interpreter 30, and the server 50 will have the same updated register data.

The user is also able to remove any of the electric devices 40 out of the application with the remote control device 10 by deleting the corresponding register data. Once any one of the register data saved in the first memory of the remote control device 10 is deleted, the corresponding register datum saved in the second memory 32 of the interpreter 30 is deleted too, but the corresponding register datum is still saved in the third memory 52 of the server 50. If the user wants to restore the deleted electric device 40 back into the application later, the register datum of the deleted electric device 40 can be retrieved from the third memory 52 of the server 50 for. With the same procedure of above, the deleted electric device 40 is then back to be controlled.

In conclusion, the present invention may label different electric devices 40 and manage them with single remote control device 10. Each electric device 40 is identified clearly with its type and location kept in its register datum. It must be pointed out that the embodiments described above are only some preferred embodiments of the present invention. All equivalent structures which employ the concepts disclosed in this specification and the appended claims should fall within the scope of the present invention.

What is claimed is:

1. A method of labeling electric devices, which is incorporated in a remote control system, and the remote control system includes a remote control device, an access point, an interpreter, and a plurality of electric devices, wherein the remote control device and the interpreter are connected to the access point, and the electric devices are connected to the interpreter for signal transmission; the remote control device has a first memory, and the interpreter has a second memory; the remote control device is installed with an application to be operated by a user to control the electric devices; and each electric device has an identifying code for identification; the method comprising the steps of:
A. transmitting the identifying codes of the electric devices to the remote control device;
B. combining a label respectively to each identifying code to form a register datum, and saving the register data in the first memory of the remote control device, wherein each label respectively contains information of one of the electric devices; and
C. transmitting the register data to the interpreter and saving the register data in the second memory.

2. The method of claim 1, wherein the remote control device has a display to show the register data for the user to control any of the electric devices.

3. The method of claim 1, wherein each label includes a description describing a type of one of the electric devices.

4. The method of claim 1, wherein each label includes a description describing a location of one of the electric devices.

5. The method of claim 1, wherein each label includes a picture showing an appearance of one of the electric devices.

6. The method of claim 1, wherein each label includes a picture showing a location of one of the electric devices.

7. The method of claim 1, further comprising:
editing one of the labels of the register data saved in the first memory of the remote control device through the application.

8. The method of claim 7, further comprising:
transmitting the edited register datum to the interpreter to overwrite the corresponding register datum saved in the second memory.

9. The method of claim 1, further comprising:
deleting one of the register data saved in the first memory of the remote control device through the application; and
deleting the corresponding register datum saved in the second memory of the interpreter.

10. The method of claim 1, further comprising:
transmitting the register data to a server to be saved in a third memory of the server.
